(19) United States
(12) Patent Application Publication
(10) Pub. No.: US 2013/0241882 A1
(43) Pub. Date: Sep. 19, 2013

(54) OPTICAL TOUCH SYSTEM AND OPTICAL TOUCH POSITION DETECTING METHOD

(71) Applicants: Chee-Chun Leung, Kuei Shan Hsiang (TW); Yun-Cheng Liu, Kuei Shan Hsiang (TW); Chien-Hung Lin, Kuei Shan Hsiang (TW)

(72) Inventors: Chee-Chun Leung, Kuei Shan Hsiang (TW); Yun-Cheng Liu, Kuei Shan Hsiang (TW); Chien-Hung Lin, Kuei Shan Hsiang (TW)

(73) Assignee: QUANTA COMPUTER INC., Kuei Shan Hsiang (TW)

(21) Appl. No.: 13/608,445

(22) Filed: Sep. 10, 2012

(30) Foreign Application Priority Data
Mar. 19, 2012 (TW) 101109283

(51) Int. Cl. G06F 3/042

(52) U.S. Cl. 345/175

(57) ABSTRACT

The invention provides an optical touch system for detecting a position of a touch object on a touch area, including an active light source for lightening the touch area, a camera having two lenses and an image sensor to capture two images of the touch object on the image sensor through the two lens, and a processor for calculating the position of the touch object according to the two images of the touch object on the image sensor.

### CROSS REFERENCE TO RELATED APPLICATIONS

This application claims priority of Taiwan Patent Application No. 101109283, filed on Mar. 19, 2012, the entirety of which is incorporated by reference herein.

### BACKGROUND OF THE INVENTION

1. Field of the Invention

The present invention relates to an optical touch system and an optical touch position detecting method, and in particular relates to an optical touch system and an optical touch position detecting method adopting a camera provided with two lenses to detect a touch position.

2. Description of the Related Art

Touch techniques applied in displays include not only embedding a capacitive or inductive touch panel in to a display device, but also disposing a camera provided with an image sensor to the periphery of the display device to optically detect touch positions.

In a conventional optical touch technique, two cameras are used and disposed at different corners of the touch surface such that the fields of view (FOV) of the two cameras both cover the entire touch surface. The touch position of a touch object at the touch surface is determined by the intersection point of the lines passing through the touch object and the two cameras.

As shown in FIG. 1, camera 101 and 102 are disposed at two corners of the touch area 103 such that the fields of view of the two cameras 101 and 102 both cover the entire touch area 103. A linear light source 104 and a retro-reflector 105 are further disposed at the boundary of the touch area 103. The retro-reflector 105 is located along three edges of the touch area 103 and is capable of reflecting any incident light beam back along its incident direction. Therefore, when the linear light source 104 lightens the entire touch area 103, the light beams are reflected by the retro-reflector 105 to the cameras 101 and 102. In this case, when a touch object touches the touch area 103 to produce a touch point 107, the touch object blocks the reflecting light beams of the directions through the touch point 107 and the cameras 101 and 102, and accordingly the cameras 101 and 102 respectively obtain a dark point at a position on the pixel array of an image sensor provided via the cameras 101 and 102. Finally, a processor 106 acquires the directions of the touch point 107 with respect to the cameras 101 and 102 and calculates the real position of the touch point 107, according to the positions of the dark points on the pixel arrays of the image sensors.

In addition, the conventional optical touch techniques also include a structure wherein a camera and a mirror are disposed at the periphery of the touch surface.

As shown in FIG. 2, a camera 201 is disposed at a corner of a touch area 203 such that the field of view of the camera 201 covers the entire touch area 203. Further, a linear light source 204 and a mirror 205 are disposed along the edges of the touch area 203. Because the camera 201 and the mirror image of the camera 201 are located at the symmetry positions with respect to the mirror 205, this configuration is substantially equal to a two-camera configuration. The linear light source 204 lightens the entire touch area 203 and the mirror 205 reflects light beams to the camera 201. When a touch object touches the touch area 203 to produce a touch point 207, the touch object blocks the light beams of the two directions reflected from the mirror 205 to the camera 201, and accordingly the camera 201 obtains two dark points at two positions on the pixel array of an image sensor provided via the camera 201. Finally, a processor 206 acquires the direction of the touch point 207 with respect to the camera 201 and calculates the real position of the touch point 207, according to the two positions of the two dark points on the pixel array of the image sensor provided via the camera 201.

However, no matter if the configuration has two cameras and a retro-reflector or a camera and a mirror, in the conventional art the camera is always a structure provided with a lens and an image sensor. Therefore, the purpose of the invention is providing an optical touch system and an optical touch position detecting method different from the conventional art. The optical touch system and the optical touch position detecting method according to the invention use a camera provided with two lenses and an image sensor to detect touch positions.

### BRIEF SUMMARY OF THE INVENTION

A detailed description is given in the following embodiments with reference to the accompanying drawings.

The invention provides an optical touch system for detecting a position of a touch object on a touch area, including: at least one active light source for lightening the touch area; a camera having two lenses and an image sensor to capture two images of the touch object on the image sensor through the two lenses; and a processor for calculating the position of the touch object according to the positions of the two images of the touch object on the image sensor, wherein the camera is disposed at the periphery of the touch area such that fields of view of the two lenses both cover the entire touch area.

In the above optical touch system, the positions of the two images on the image sensor correspond to two angle parameters, wherein the angle parameters are values of an angle between a predetermined reference line and a line passing the position of the touch object and one of the two lenses. A two-dimensional coordinate system is used to define the position of a point on the touch area with a coordinate, and the processor uses the two angle parameters and the coordinates of the two lenses to calculate the coordinate of the touch object.

In the above optical touch system, the predetermined reference line is parallel with the x-axis of the two-dimensional coordinate system and the processor calculates the coordinate (x, y) of the touch object according to the following equations:

(y−y₁)/(x−x₁)=tan θ₁;

(y−y₂)/(x−x₂)=tan θ₂,

wherein (x₁, y₁) is the coordinate of a first lens of the two lenses, θ₁ is the angle parameter with respect to the first lens, (x₂, y₂) is the coordinate of a second lens of the two lenses, and θ₂ is the angle parameter with respect to the second lens.

In the above optical touch system, the angle parameter θ₁ corresponds to a pixel position within an image range of the first lens on the image sensor, and the angle parameter θ₂ corresponds to a pixel position within an image range of the second lens on the image sensor, wherein the angle parameters θ₁ and θ₂ are determined by the two pixel positions of the two images formed on the image sensor through the first lens and the second lens.

According to an embodiment of the invention, the active light source is disposed on the camera and provides light with enough intensity such that the light omitted from the active light source can be reflected by the touch object to the camera.

According to an embodiment of the invention, the optical touch system further includes: at least one retro-reflector disposed at the periphery of the touch area, wherein the light omitted from the active light source is reflected by the retro-reflector such that the image background captured by the image sensor is a bright background.

According to an embodiment of the invention, the active light source is an infrared light emitting diode or an infrared light diode, and the image sensor is capable of detecting infrared light images.

The invention also provides an optical touch position detecting method, including: using a camera provided with two lenses and an image sensor to receive images of a touch object; and calculating the position of the touch object according to the positions of two images of the touch object formed on the image sensor through the two lenses.

In the above optical touch position detecting method, the positions of the two images on the image sensor correspond to two angle parameters, wherein the angle parameters are values of an angle between a predetermined reference line and a line passing the position of the touch object and one of the two lenses.

The above optical touch position detecting method further includes using a two-dimensional coordinate system to define the position of a point on the touch area with a coordinate, and using the two angle parameters and the coordinates of the two lenses to calculate the coordinate of the touch object.

In the above optical touch position detecting method, the predetermined reference line is parallel with the x-axis of the two-dimensional coordinate system and the coordinate (x, y) of the touch object is calculated according to the following equations:

(y−y₁)/(x−x₁)=tan θ₁;

(y−y₂)/(x−x₂)=tan θ₂,

wherein (x₁, y₁) is the coordinate of a first lens of the two lenses, θ₁ is the angle parameter with respect to the first lens, (x2, y2) is the coordinate of a second lens of the two lenses, and θ₂ is the angle parameter with respect to the second lens.

In the above optical touch position detecting method, the angle parameter θ₁ corresponds to a pixel position within an image range of the first lens on the image sensor, and the angle parameter θ₂ corresponds to a pixel position within an image range of the second lens on the image sensor, wherein the angle parameters θ₁ and θ₂ are determined by the two pixel positions of the two images formed on the image sensor through the first lens and the second lens.

According to the optical touch system and the optical touch position detecting method of the invention, a camera provided with two lenses and an image sensor is used, and an active light source is disposed on the camera to lighten a touch object such that the camera receives reflected light from the touch object for detecting the touch position of the touch object. Therefore, the invention provides a new optical touch system and optical touch position detecting method different from the conventional art.

### BRIEF DESCRIPTION OF THE DRAWINGS

The present invention can be more fully understood by reading the subsequent detailed description and examples with references made to the accompanying drawings, wherein:

FIG. 1 is a configuration diagram showing a conventional optical touch system.

FIG. 2 is a configuration diagram showing another conventional optical touch system.

FIG. 3 is a configuration diagram showing an optical touch system in accordance with an embodiment of the invention.

FIG. 4 is a diagram for explaining the angle acquiring method of the optical touch system in accordance with the embodiment of the invention.

FIG. 5 is a diagram for explaining the angle acquiring method of the optical touch system in accordance with the embodiment of the invention.

FIG. 6 is a diagram for explaining the angle acquiring method of the optical touch system in accordance with the embodiment of the invention.

FIG. 7 is a configuration diagram showing an optical touch system in accordance with another embodiment of the invention.

FIG. 8 is a configuration diagram showing an optical touch system in accordance with another embodiment of the invention.

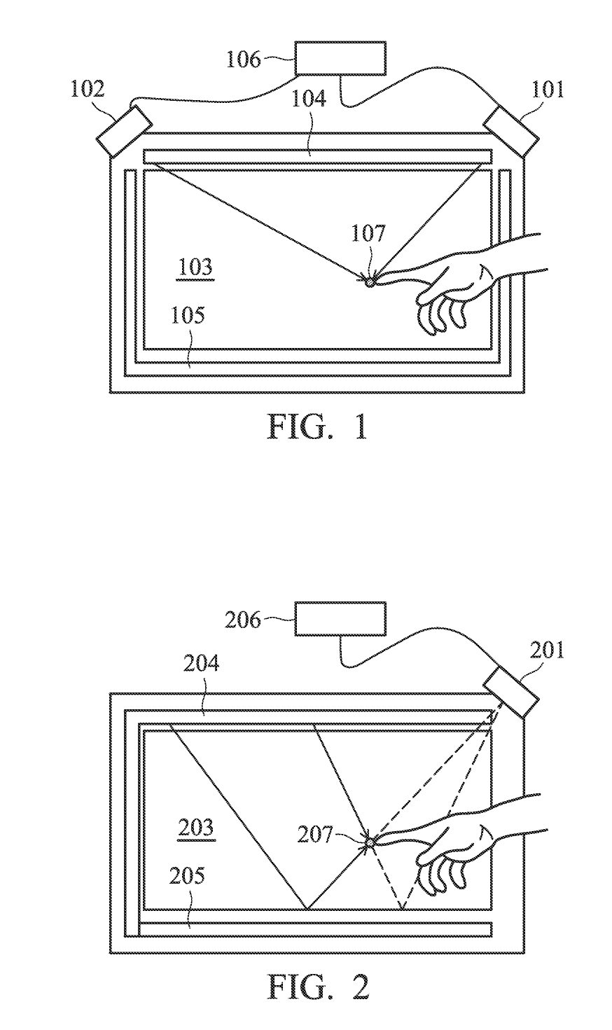

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

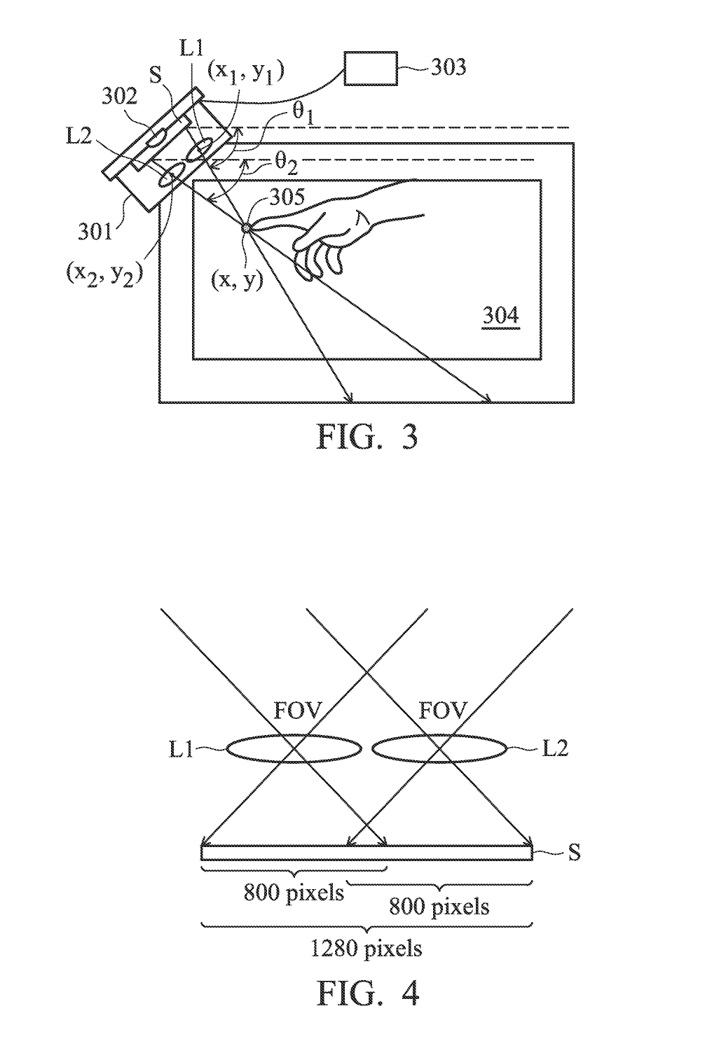

FIG. 3 is a configuration diagram showing an optical touch system in accordance with an embodiment of the invention. As shown in FIG. 3, the optical touch system of the embodiment comprises a camera 301, an active light source 302 and a processor 303. The camera 301 has two lenses L1 and L2 and an image sensor S. The camera 301 is disposed at a corner of a touch area 304, such that the fields of view of the lenses L1 and L2 can both cover the entire touch area 304 and the touch object can be completely imaged on the image sensor S through any one of the lens L1 and lens L2. The active light source 302 is fixed on the camera 301 to lighten the touch object located on the touch area 304. The touch object reflects the light beam omitted from the active light source 302 to the camera 301. The processor 303 is used for calculating the position of the touch point 305 of the touch object.

Next, a touch position detecting method applied to this optical touch system is described. As shown in FIG. 3, every point on the surface of the touch area 304 is defined by a two-dimensional coordinate system. It is supposed that the position of the touch point is (x, y), the intersection point of the field of view of the lens L1 (the center point of the lens L1 in FIG. 3) is (x₁, y₁), and the intersection point of the field of view of the lens L2 (the center point of the lens L2 in FIG. 3) is (x₂, y₂). Further, it is supposed that the angle between a line passing through the touch point 305 and the lens L1 and an edge of the touch area 304 (the length of the rectangular touch area 304 in this embodiment) is θ₁, and the angle between a line passing through the touch point 305 and the lens L2 and the same edge of the touch area 304 is θ₂. Therefore, according to the trigonometric function, the following linear Equations are obtained.

(y−y₁)/(x−x₁)=tan θ₁ (1)

(y−y₂)/(x−x₂)=tan θ₂ (2)

Because of the fixed positions of the lenses L1 and L2, x₁, y₁, x₂, and y₂ are known constants. Therefore, as long as θ₁ and θ₂ are acquired, the position (x, y) of the touch point 305 can be derived from the above equations. The acquiring method for θ₁ and θ₂ is described below.

FIGS. 4-6 are diagrams for explaining the angle acquiring method of the optical touch system in accordance with the embodiment of the invention. FIG. 4 shows fields of view FOV of the lenses L1 and L2 and their image ranges on the image sensor S. Assume that the image sensor S has 1280 pixels (pixel number 0˜1279) and the image ranges of the lenses L1 and L2 are both 800 pixels. Therefore, the image range of the lens L1 and the image range of the lens L2 are overlapped. Also refer to FIG. 6, the image range R1 of the lens L1 on the image sensor S is a range including 0^{th}˜799^{th} pixels, and the image range R2 of the lens L2 on the image sensor S is a range including 480^{th}˜1279^{th} pixels.

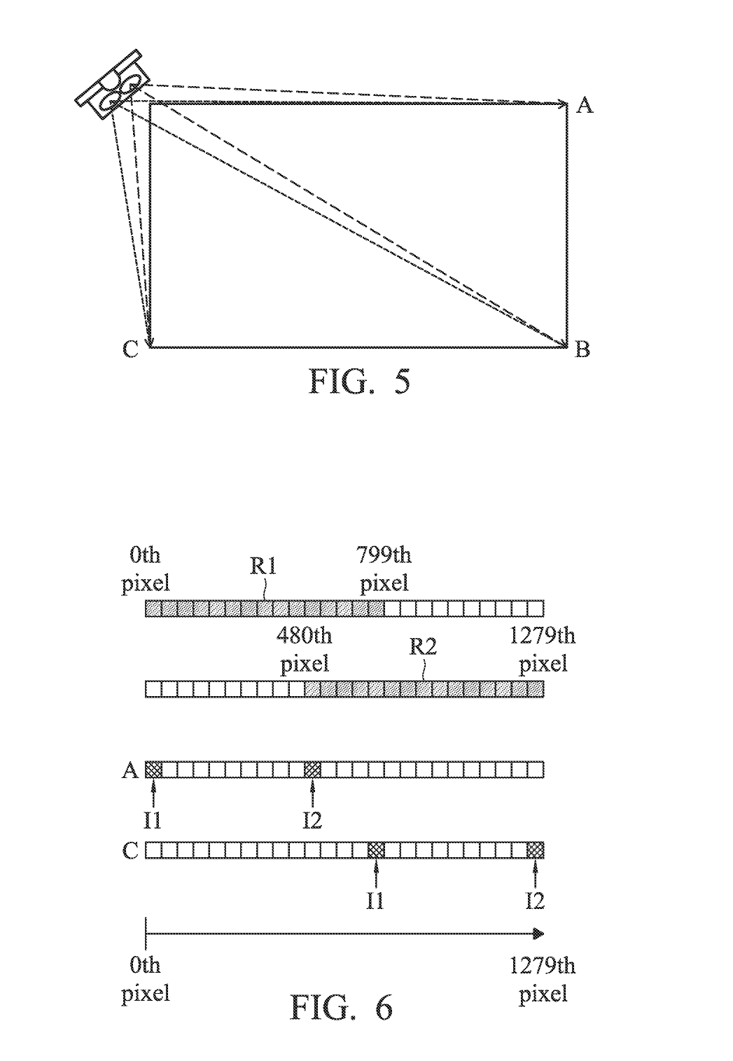

As shown in FIG. 5, fields of view FOV of the lenses L1 and L2 must both cover the entire touch area 304. Namely, the lenses L1 and L2 are both capable of detecting at least touches at point A and at point C. Here, for easy understanding, assume that fields of view FOV of the lenses L1 and L2 are both equal to a range from point A to point C. When a touch object touches point A, the light beams omitted from the active light source 302 are reflected by the touch object to the camera 301. Therefore, because of the touch at point A, two bright points are produced on the image sensor S by light beams passing through the lenses L1 and L2. As shown in FIG. 6, the two bright points are located at the 0^{th} pixel and the 480^{th} pixel, respectively, wherein the bright point located at the 0^{th} pixel is the image I1 through the lens L1 and the bright point located at the 480^{th} pixel is the image I2 through the lens L2. On the other hand, when a touch object touches point C, two bright points are located at the 799^{th} pixel and the 1279^{th} pixel, respectively, wherein the bright point located at the 799^{th} pixel is the image I1 through the lens L1 and the bright point located at the 1279^{th} pixel is the image I2 through the lens L2.

From the above description it is known that for a lens, the touch object located at different angle positions is imaged to different corresponding pixel positions of the image sensor S. The angle θ₁ between the line passing through the touch point 305 and the lens L1 and the edge of the touch area 304 corresponds to a pixel position between the 0^{th} and the 799^{th} pixel on the image sensor S. The angle θ₂ between the line passing through the touch point 305 and the lens L1 and the edge of the touch area 304 corresponds to a pixel position between the 480^{th} and the 1279^{th} pixel on the image sensor S. This characteristic is used to depict a curve diagram showing the relation between the pixel position on the image sensor S and the angle position of the touch object. Then two pixel positions of the images of the touch object on the image sensor S are used to derive the angles θ₁ and θ₂, which are angles between the touch point 305 and the edge of the touch area 304 with respect to the lenses L1 and L2, respectively.

Finally, the values of the angles θ₁ and θ₂ are used to substitute the variables θ₁ and θ₂ in the above equations (1) and (2) to derive the position (x, y) of the touch point 305.

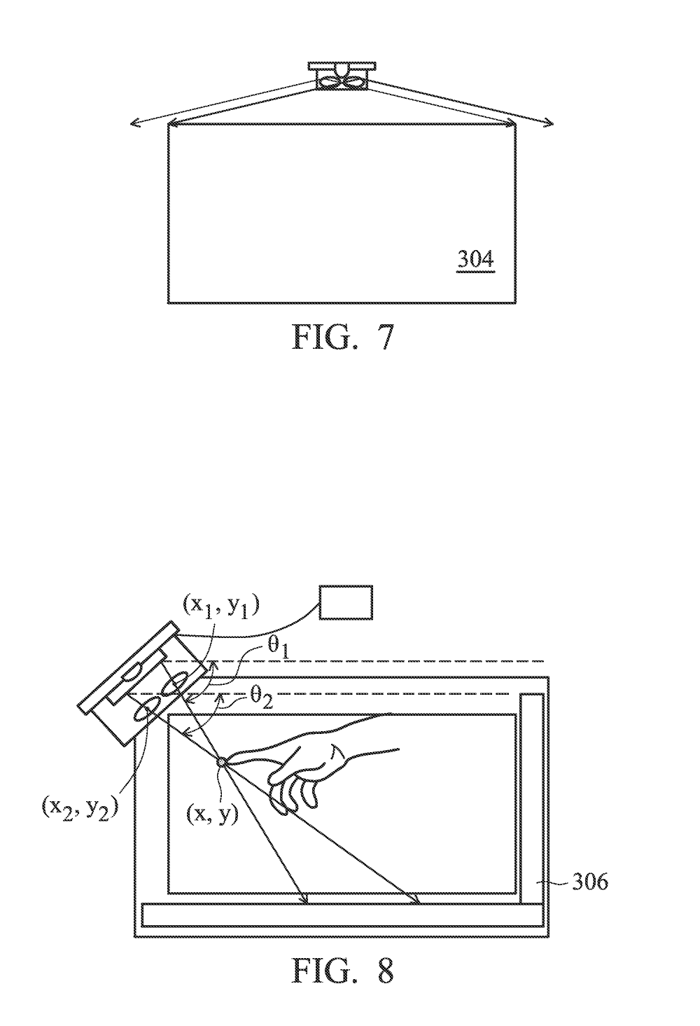

According to the above embodiment, the optical touch system of the invention uses a camera provided with two lenses and an image sensor to detect touch positions. However, various kinds of configurations can be applied in the optical touch system of the invention. As shown in FIG. 7, the camera 301 is not limited to be disposed at a corner of the touch area 304. As long as fields of view FOV of the two lenses L1 and L2 cover the entire touch area 304, the camera 301 can also be disposed, for example, at the upper edge of the touch area 304.

Furthermore, in the optical touch system in accordance with the above embodiment, the touch object reflects the light omitted from the active light source 302 to the camera 301, and the processor 303 calculates the touch position by detecting the pixel positions of the bright points on the image sensor. However, as shown in FIG. 8, a retro-reflector 306 can be disposed along two edges of the touch area 304, opposite to the camera 301. In this way, the retro-reflector 306 reflects light beams from all direction to the camera 301 such that the image sensor S is totally bright. When a touch object touches the touch area 304, the touch object blocks the reflected light beams from specific directions and therefore two dark points are generated in the bright background in the image sensor S. Accordingly, the method which detects dark points in the bright background is contrary to the before-mentioned method which detects bright points in the dark background.

The optical touch system and the optical touch position detecting method are described above. However, different touch objects have different characteristics such as different thicknesses. In this case, before a normal touch operation, the touch object can touch at least one specified reference point on the touch area in advance for angle calibration. In this way, the calculation for touch position becomes more accurate during normal touch operations.

According to the optical touch system and the optical touch position detecting method of the invention, a camera provided with two lenses and an image sensor is used, and an active light source is disposed on the camera to lighten a touch object such that the camera receives reflected light from the touch object for detecting the touch position of the touch object. Therefore, the invention provides a new optical touch system and optical touch position detecting method different from the conventional art.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements. For example, the active light can be an infrared light emitting diode or an infrared light diode. In this case, the image sensor must be capable of detecting infrared light images. Moreover, the lens L1 or L2 is described as a single lens in the embodiment, but the lens L1 or L2 can be a lens group consisting of a plurality of lenses.

What is claimed is:

1. An optical touch system for detecting a position of a touch object on a touch area, comprising:
at least one active light source for lightening the touch area;
a camera having two lenses and an image sensor to capture two images of the touch object on the image sensor through the two lenses; and
a processor for calculating the position of the touch object according to the positions of the two images of the touch object on the image sensor,
wherein the camera is disposed at the periphery of the touch area such that fields of view of the two lenses both cover the entire touch area.

2. The optical touch system as claimed in claim 1, wherein the positions of the two images on the image sensor correspond to two angle parameters,
wherein the angle parameters are values of an angle between a predetermined reference line and a line passing the position of the touch object and one of the two lenses.

3. The optical touch system as claimed in claim 2, wherein a two-dimensional coordinate system is used to define the position of a point on the touch area with a coordinate, and the processor uses the two angle parameters and the coordinates of the two lenses to calculate the coordinate of the touch object.

4. The optical touch system as claimed in claim 3, wherein the predetermined reference line is parallel with the x-axis of the two-dimensional coordinate system and the processor calculates the coordinate (x, y) of the touch object according to the following equations:
(y−y₁)/(x−x₁)=tan θ₁;
(y−y₂)/(x−x₂)=tan θ₂,
wherein (x₁, y₁) is the coordinate of a first lens of the two lenses, θ₁ is the angle parameter with respect to the first lens, (x₂, y₂) is the coordinate of a second lens of the two lenses, and θ₂ is the angle parameter with respect to the second lens.

5. The optical touch system as claimed in claim 4, wherein the angle parameter θ₁ corresponds to a pixel position within an image range of the first lens on the image sensor, and the angle parameter θ₂ corresponds to a pixel position within an image range of the second lens on the image sensor,
wherein the angle parameters θ₁ and θ₂ are determined by the two pixel positions of the two images formed on the image sensor through the first lens and the second lens.

6. The optical touch system as claimed in claim 1, wherein the active light source is disposed on the camera and provides light with enough intensity such that the light omitted from the active light source can be reflected by the touch object to the camera.

7. The optical touch system as claimed in claim 1, further comprising:
at least one retro-reflector disposed at the periphery of the touch area,
wherein the light omitted from the active light source is reflected by the retro-reflector such that the image background captured by the image sensor is a bright background.

8. The optical touch system as claimed in claim 1, wherein the active light source is an infrared light emitting diode or an infrared light diode, and the image sensor is capable of detecting infrared light images.

9. An optical touch position detecting method, comprising:
using a camera provided with two lenses and an image sensor to receive images of a touch object; and
calculating the position of the touch object according to the positions of two images of the touch object formed on the image sensor through the two lenses.

10. The optical touch position detecting method as claimed in claim 9, wherein the positions of the two images on the image sensor correspond to two angle parameters,
wherein the angle parameters are values of an angle between a predetermined reference line and a line passing the position of the touch object and one of the two lenses.

11. The optical touch position detecting method as claimed in claim 10, further comprising:
using a two-dimensional coordinate system to define the position of a point on the touch area with a coordinate, and
using the two angle parameters and the coordinates of the two lenses to calculate the coordinate of the touch object.

12. The optical touch position detecting method as claimed in claim 11, wherein the predetermined reference line is parallel with the x-axis of the two-dimensional coordinate system and the coordinate (x, y) of the touch object is calculated according to the following equations:
(y−y₁)/(x−x₁)=tan θ₁;
(y−y₂)/(x−x₂)=tan θ₂,
wherein (x₁, y₁) is the coordinate of a first lens of the two lenses, θ₁ is the angle parameter with respect to the first lens, (x₂, y₂) is the coordinate of a second lens of the two lenses, and θ₂ is the angle parameter with respect to the second lens.

13. The optical touch position detecting method as claimed in claim 12, wherein the angle parameter θ₁ corresponds to a pixel position within an image range of the first lens on the image sensor, and the angle parameter θ₂ corresponds to a pixel position within an image range of the second lens on the image sensor,
wherein the angle parameters θ₁ and θ₂ are determined by the two pixel positions of the two images formed on the image sensor through the first lens and the second lens.
